(19) United States
(12) Patent Application Publication
(10) Pub. No.: US 2017/0306687 A1
(43) Pub. Date: Oct. 26, 2017

(54) Removable Door or Window Frame Assembly

(71) Applicant: MENUISERIE ARCHITECTURALE JOËL LAMOTHE INC., Sainte-Marguerite-du-Lac-Marier (CA)

(72) Inventor: Joël Lamothe, Sainte-Marguerite-du-Lac-Marier (CA)

(73) Assignee: MENUISERIE ARCHITECTURALE JOËL LAMOTHE INC., Sainte-Marguerite-du-Lac-Marier (CA)

(21) Appl. No.: 15/496,990

(22) Filed: Apr. 25, 2017

(30) Foreign Application Priority Data
Apr. 25, 2016 (CA) 2928151

(51) Int. Cl. E06B 1/08; E06B 3/46; E06B 3/54; E06B 7/14

(52) U.S. Cl. CPC E06B 1/08; E06B 7/14; E06B 3/4618; E06B 3/5409

(57) ABSTRACT

A frame assembly for installation into a door or window casing is provided. The casing has a top and two side studs. The assembly includes a head jamb, a pair of side jambs, and a pair of connecting mechanism. The head jamb is removably securable to the top stud. Each side jamb is removably securable to a respective one of the two side studs. Each connecting mechanism for connecting a respective one of the side jambs with a corresponding end of the head jamb includes a first component and a second component. The first component is provided on the head jamb, and the second component is provided on the side jambs. The first and second components are removably engageable, and allow the frame assembly to be installed and uninstalled from the door or window casing. A method for removably installing the frame assembly is also provided.

### CROSS-REFERENCE TO RELATED APPLICATIONS

This application claims the benefit of priority of Canadian patent application no. 2,928,151 filed 25 Apr. 2016, which is hereby incorporated herein by reference in its entirety.

### TECHNICAL FIELD

The technical field generally relates to frame assembly for door or window openings, and method for installing such frame assemblies. More particularly, the technical field relates to a frame assembly that may be installed or uninstalled from the door or window opening.

### BACKGROUND

Typical frame assemblies are carpentry structures including several parts intended to be assembled around an opening in a wall (e.g. door or window).

Frame assemblies known in the art are associated with several challenges and problems. For example, their installation may require a considerable amount of time. Furthermore, assembling and installing such frame assemblies may be difficult for people lacking the necessary skills and/or minimal knowledge required for carpentry activities. Another drawback associated with frame assemblies known in the art is that when it is required to uninstall the frame assembly from the opening, a user would typically have to damage and/or destroy the frame assembly's components.

There is thus presently a need for a frame assembly for door or window opening, and method for installing such frame assembly that address at least some of the challenges presented above.

### SUMMARY

In accordance with one aspect, there is provided a frame assembly for installation into a door or window casing. The casing has a top and two side studs. The assembly includes a head jamb, a pair of side jambs, and a pair of connecting mechanism. The head jamb is removably securable to the top stud, and the head jamb has two opposed ends. Each side jamb has two opposed ends and is removably securable to a respective one of the two side studs. Each connecting mechanism for connecting a respective one of the side jambs with a corresponding end of the head jamb includes a first component and a second component. The first component is provided at the corresponding end of the head jamb, and the second component is provided at one of the two opposed ends of the respective one of the side jambs. The first and second components are removably engageable, and allow the frame assembly to be installed and uninstalled from the door or window casing.

In one embodiment, the assembly further includes top securing components for removably securing the head jamb to the top stud.

In one embodiment, the top securing components include at least one screw and the head jamb includes at least one hole traversable by at least one screw.

In one embodiment, each of the side jambs comprises an adjustment mechanism. The adjustment mechanism includes at least one screw and at least one washer mounted onto the at least one screw. The at least one washer is engageable with a respective side stud through rotation of the at least one screw.

In one embodiment, the head jamb and each side jambs include a support base and two casing mouldings. The support base has two longitudinally-extending sides. The two casing mouldings are mounted to the support base along the two longitudinally-extending sides and are perpendicularly extending therefrom, towards the casing.

In one embodiment, the first component of each of the connecting mechanisms is a threaded rod.

In one embodiment, the second component is a hole in which the first component is removably insertable.

In one embodiment, the assembly further includes a recess extending along a portion of the side jamb proximate one of the two opposed ends of the respective one of the side jambs. The recess is communicating with the hole.

In one embodiment, the threaded rod passes through the hole and extends at least partially in the recess.

In one embodiment, the assembly further includes a fixing nut removably engageable with the threaded rod.

In one embodiment, the assembly further includes a pair of cabling systems. Each cabling system includes a fixing head, a winch, and a cable. The fixing head is mounted onto the head jamb. The winch is mounted onto a respective one of the pair of side jambs. The cable has a first end engaged with the fixing head and a second end rotatably attached to the winch.

In one embodiment, the fixing head is a metal ball.

In one embodiment, the assembly further includes a recess and restraining elements. The recess is provided onto the head jamb for receiving the metal ball. The restraining elements is for holding the metal ball into the recess.

In one embodiment, the restraining elements are at least one pair of screw and corresponding washer.

In one embodiment, the winch includes a shaft defining a rotation axis and a hexagonal top head affixed to said shaft. The winch is rotatable about the rotation axis through rotation of the hexagonal top head, and allows to wind up the cable onto the shaft of the winch.

In one embodiment, the winch further includes a winch head and a locking element engaging with at least one of the winch head, the cable and the shaft.

In one embodiment, the head jamb defines two top corners with the pair of side jambs. The assembly further includes reinforcement elements provided at the two top corners.

In one embodiment, the reinforcement elements are L-shaped mounting bracket.

In accordance with another aspect, there is provided a method for removably installing a frame assembly into a door or window casing, the casing having a top and two side studs, the method comprising steps of removably securing a head jamb to the top stud, the head jamb having two opposed ends; removably securing a pair of side jambs to a respective one of the two side studs, each side jamb having two opposed ends; and connecting a respective one of the side jambs with a corresponding end of the head jamb through a pair of connecting mechanisms each comprising a first component provided at the corresponding end of the head jamb and a second component provided at one of the two opposed ends of the respective one of the side jambs, the first and second components being removably engaged, thereby allowing the frame assembly to be uninstalled from the door or window casing.

Other features and advantages of the invention will be better understood upon reading of embodiments thereof with reference to the appended drawings.

### BRIEF DESCRIPTION OF THE DRAWINGS

FIG. 1 shows a front view of a frame assembly installed in a door casing, according to one embodiment.

FIG. 2 shows a side view of the frame assembly of FIG. 1.

FIG. 3 shows a front view of a frame assembly installed in a door casing, according to one embodiment.

FIG. 4 shows a side view of the frame assembly of FIG. 3.

FIG. 5 shows a front view of a frame assembly installed in a door casing, according to one embodiment.

FIG. 6 shows a side view of the frame assembly of FIG. 5.

FIGS. 7A to 7D show a connecting mechanism for connecting a head jamb with a side jamb, according to one embodiment.

FIG. 8 shows a top perspective view of a frame assembly installed in a door casing, according to one embodiment

FIGS. 9A to 9C show steps for assembly a frame assembly, according to one embodiment.

### DETAILED DESCRIPTION

In the following description, similar features in the drawings have been given similar reference numerals. In order to not unduly encumber the figures, some elements may not be indicated on some figures if they were already mentioned in preceding figures. It should also be understood herein that the elements of the drawings are not necessarily drawn to scale and that the emphasis is instead being placed upon clearly illustrating the elements and structures of the present embodiments.

The present description generally relates to a frame assembly for installation into a door and window casing.

In the present description, the expressions “casing”, “opening”, “opening into a wall”, derivatives and variants thereof refer to a space or an opening provided in a wall (i.e. a structure connecting a floor with a ground and enclosing a room) and having a plurality of sides defined by studs. The expression “studs” herein refers to upright(s) or lintel(s) in the framing of the walls to which are typically attached sheath, panels or laths. A door or a window may be mounted in the casing.

In the present description, the expressions “removably securable”, “removably inserted”, “removably engaged”, “removably connected”, or variants thereof refer to a property of a piece or a group of pieces of forming a non-permanent joint (i.e. a joint that may be assembled and disassembled when needed).

Some embodiments may be particularly useful for any kind of users (non-professional and professional) wanting to install a frame assembly for residential or commercial applications. Installation of the frame assembly according to some embodiments requires minimal knowledge, tools and craftsmanship in carpentry or construction. The amount of time typically required to install the frame assembly described herein below may be reduced with respect with the amount of time required to install frame assembly from prior art. Advantageously, the frame assembly of the following embodiments may be uninstalled and reinstalled from one casing to another, without damaging the components included in the frame assembly.

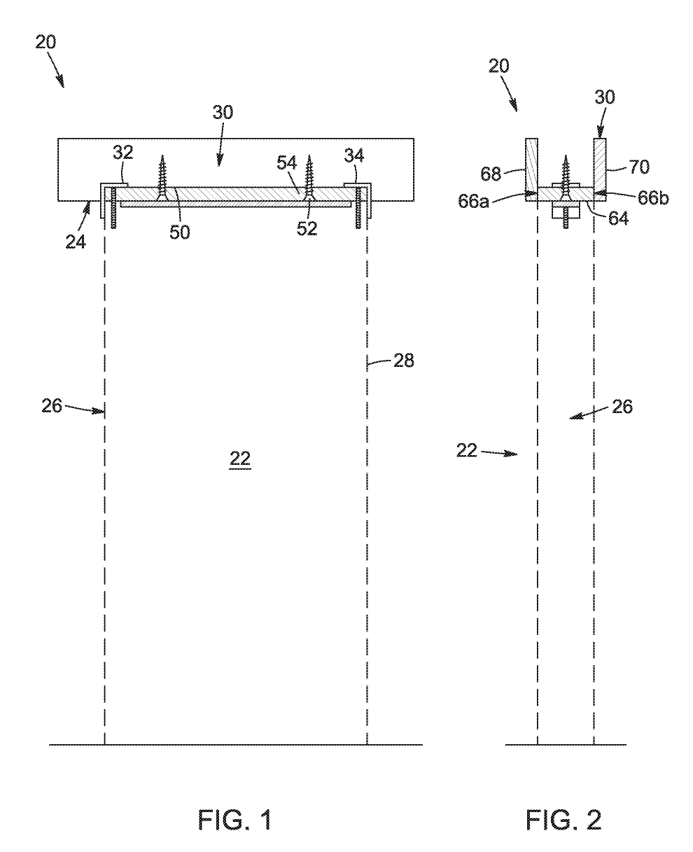

Referring to FIG. 1, an embodiment of a frame assembly 20 is shown. The frame assembly 20 may be installed into a door or window casing 22. The casing 22 has a top stud 24 and two side studs 26,28.

The frame assembly 20 includes a head jamb 30 that may be secured to the top stud 24. The head jamb 30 is typically made of wood, but could also alternatively be made from medium-density fibreboard (MDF), metal, ceramics, variants and combinations thereof, as long as the selected material has the required mechanical properties and structure to be secured to the top stud 24.

The head jamb 30 has two opposed ends 32, 34. In some alternatives, each one of the ends 32,34 could be truncated or provided with a groove or recess of various geometrical configurations, so as to accommodate the passage of pieces, components, structural elements, wires, pipes or any other elements that may be provided or mounted close to the head jamb 30 (i.e. near the top stud 24).

In some embodiments, the head jamb 30 is sized and dimensioned to respect one or more standards of the industry. For example, the head jamb 30 may be 2 feet long. Of course, the length of the head jamb 30 may vary according to the dimensions of the door or the window to be installed in the casing 22.

The frame assembly 20 may further includes top securing components 50 for removably securing the head jamb 30 to the top stud 24.

The top securing components 50 may include, for example, at least one screw 52. In this configuration, the head jamb 30 includes at least one hole 24 through which may be inserted the screw 52, so as to allow the head jamb 30 to be secured to the top stud. As illustrated, the head jamb 30 includes two holes 54 disposed close to a respective one of the two ends 32,34, and two screws 52 are inserted into a respective hole 54. The two screws 52 are engaged with the top stud 24, the head jamb 30 is hence installed (i.e. removably secured) to the top stud. Because the head jamb 30 is removably secured to the top stud 24, it could also be uninstalled from the top stud 24, if needed. It will readily be understood that the top securing components 50 could include a broad variety of securing components that are not limited to screws. Indeed, the top securing components 50 could include nails, rods, nuts, glue, clips, pins, dowels, biscuits, snap-lock mechanism, variants and combinations thereof, as long at they allow to the head jamb 30 to be selectively installed or uninstalled (i.e. removably secured) to the top stud 24. As such, the top securing components 50 may be understood as “fasteners” for affixing at least two elements (e.g. the head jamb 30 and the top stud 24) or for forming non-permanent joints (i.e. joints that can be removed, uninstalled or dismantled without damaging the components forming the joints).

In some embodiments, a door or window stop (not shown) may be provided on the head jamb 30. The door stop may be embodied, for example, by a piece a wood extending along at least a portion of the head jamb 30, and having a width that is typically smaller than the width of the head jamb 30.

As better illustrated in FIG. 2, the head jamb 30 may further include a support base 64 and two casing mouldings 68,70. The support base 64 has two longitudinally-extending sides 66a,b. The two casing mouldings 68,70 are mounted to the support base 64 along the two longitudinally-extending sides 66a,b and are perpendicularly extending therefrom, towards the casing 22. As such the head jamb 30 has a U-shaped cross-section compatible with the top stud 24. More particularly, when the head jamb 30 is installed into the door or window casing 22, the top stud 24 (or at least a portion of the top stud 24) is inserted into the hollow portion of the U-shaped cross-section of the head jamb 30.

As illustrated, the support base 64 has the shape of a rectangular prism (or, alternatively, a rectangular parallelepiped). It will be readily understood that the geometrical configuration (i.e. the shape and/or dimensions) of the support base 64 may vary according to one's need. For example, the support base 64 may have one or more beveled end(s).

The top securing components 50 previously described are typically provided on the support base 64, but could also be mounted onto at least one of the two casing mouldings 68,70. When the top securing components 50 are provided on the support base 64, different kinds of fasteners may be provided to removably attach each one of the two casing mouldings 68,70 to the top stud 24.

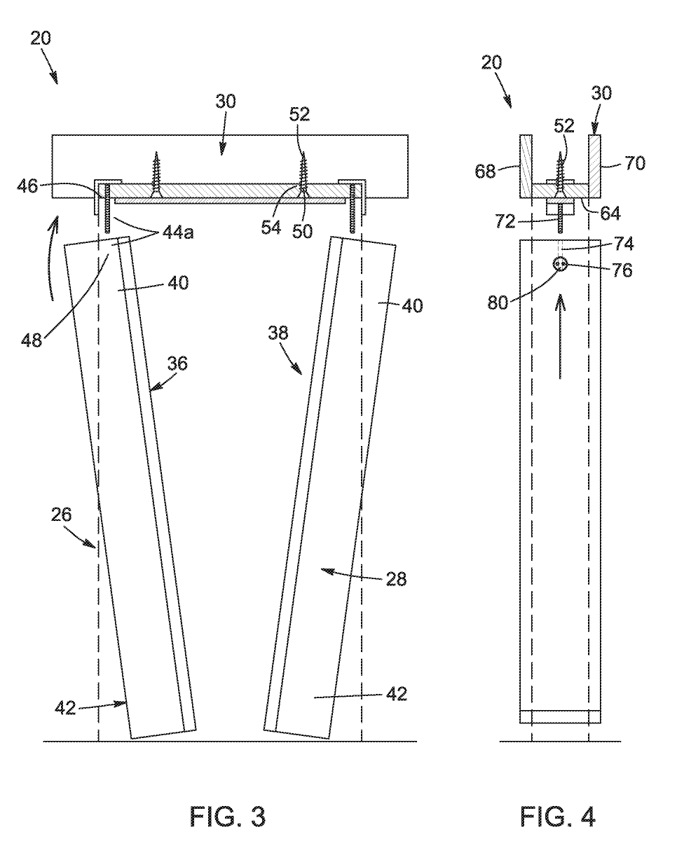

Now referring to FIGS. 3 to 6, the frame assembly 20 further includes a pair of side jambs 36,38 (herein referred to as “side jambs”) that may be removably secured to a respective one of the two side studs 26,28. The side jambs 36,38 are typically made of wood, but could also alternatively be made from metal, ceramics, variants and combinations thereof, as long as the selected material has the required mechanical properties and structure to be secured to the side studs 26,28.

The side jambs 36,38 each have two opposed ends 40,42. In some alternatives, each one of the ends 40,42 could be truncated or provided with a groove or recess of various geometrical configurations, so as to accommodate the passage of pieces, components, structural elements, wires, pipes or any other elements that may be provided or mounted close to the side jamb 36,38 (i.e. near the side studs 26,28).

In some embodiments, the side jambs 36,38 are sized and dimensioned to respect one or more standards of the industry. For example, the head jamb 30 may be six feet long. Of course, the length of the side jambs may vary according to the dimensions of the door or the window to be installed in the casing 22.

The assembly 20 may also comprise an adjustment mechanism 56 for adjusting a position of the side jambs 36,38 with respect with the side studs 26, 28. The adjustment mechanism 56 may be mounted onto the side jambs 36,38 and inserted into holes 58.

The adjustment mechanism 56 includes at least one screw 60 and at least one washer 62 mounted onto the at least one screw 60. The at least one washer 62 is engageable with the respective side studs 26, 28 through rotation of the at least one screw 60. Rotation of the at least one screw 30 may allow adjusting, for example, a distance between the side studs 26, 28 and the side jambs 36,38. When the at least one washer 62 is in contact (i.e. “engaged”) with the side jambs 36, 38, the remaining between the side studs 26,28 and the side jambs 36,38 may be filled with a shim, a washer, or a thin strip made from any material that may be useful to align the side jambs 36,38.

Alternatively, the assembly 20 could be provided with side securing components. Similarly to the top securing components 50, the side securing components may be understood as “fasteners” for affixing at least two elements (e.g. the side jambs 36,38 and the corresponding) or for forming non-permanent joints (i.e. joints that can be removed, uninstalled or dismantled without damaging the components forming the joints).

In some embodiment, a band 59 may be provided on each of the side jambs 36,38. For example, the band 59 may be provided near the end 42 of the side jambs 36, 38 and conform to the U-shaped cross-section of the side jambs 36,38. The band 59 may project from the side jambs 36,38 to allow fixing (i.e. attaching) the band 59 with a wall located near the door or window casing.

In some embodiments, a door or window stop (not shown) may be provided on the side jambs 36,38. The door stop may be embodied, for example, by a piece a wood extending along at least a portion of the side jambs 36,38, and having a width that is typically smaller than the width of the head jamb 36,38.

Similarly to the what has been described with respect with the head jamb 30, the side jambs 36,38 may further include a support base 64 and two casing mouldings 68,70. When the side jambs 36,38 are installed into the door or window casing 22, the side studs 26,28 (or at least a portion of the side studs 26,28) are inserted into the hollow portion of the U-shaped cross-section of the side jambs 36,38.

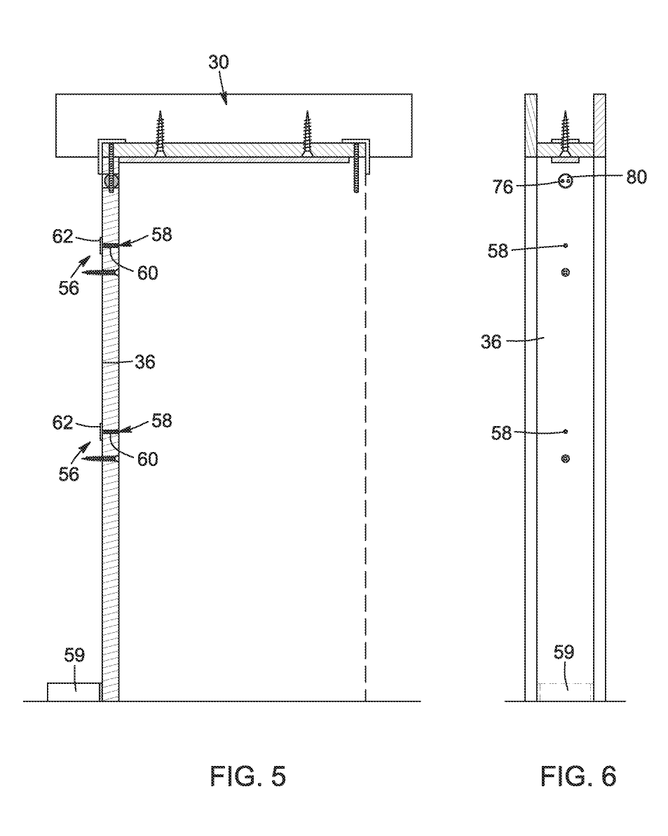

Referring now to FIGS. 5 and 6 an embodiment of the frame assembly 20 is shown.

The frame assembly 20 further comprises a pair of connecting mechanism 44a,b. As it has been previously explained, the head jamb 30 is removably securable to the top stud 24, and the head jamb has two opposed ends 32, 34. Each side jamb 36,38 has two opposed ends 40,42 and is removably securable to a respective one of the two side studs 26,28.

Each one of the connecting mechanisms 44a,b connects a respective one of the side jambs 36,38 with a corresponding end 32,34 of the head jamb 30.

In the illustrated variant, the connecting mechanisms 44a,b each includes a first component 46 and a second component 48. The first component 46 is provided at the corresponding end 32,24 of the head jamb 30, and the second component 48 is provided at one of the two opposed ends 40,42 of the respective one of the side jambs 36,38. The first and second components 46,48 are removably engageable, and allow the frame assembly 20 to be installed and uninstalled from the door or window casing 22.

In some embodiments, the first component 46 of each of the connecting mechanisms 44a,44b is a threaded rod 72. Alternatively, the first component 46 could be a threaded rod, a key, biscuits, a tenon, combinations thereof or any other piece(s) projecting from the head jamb 30. It will be readily understood that the first component 46 is removably insertable to the side jambs 36,38, but could also be embodied by any component or mechanism that is matably engageable to the side jambs 36,38. The first component 46 may be made of wood, MDF, metal, plastic, variants, or a combination thereof.

In some embodiments, the second component 48 is a hole 74 in which the first component is removably insertable. Alternatively, the second components 48 could be a hole, a recess, a mortise, slits or any other structure allowing the insertion of the first component 46.

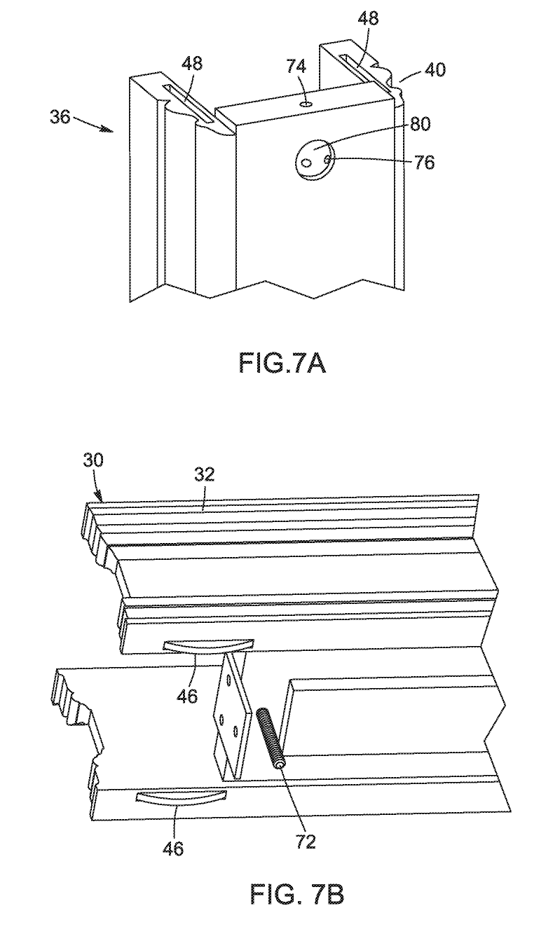

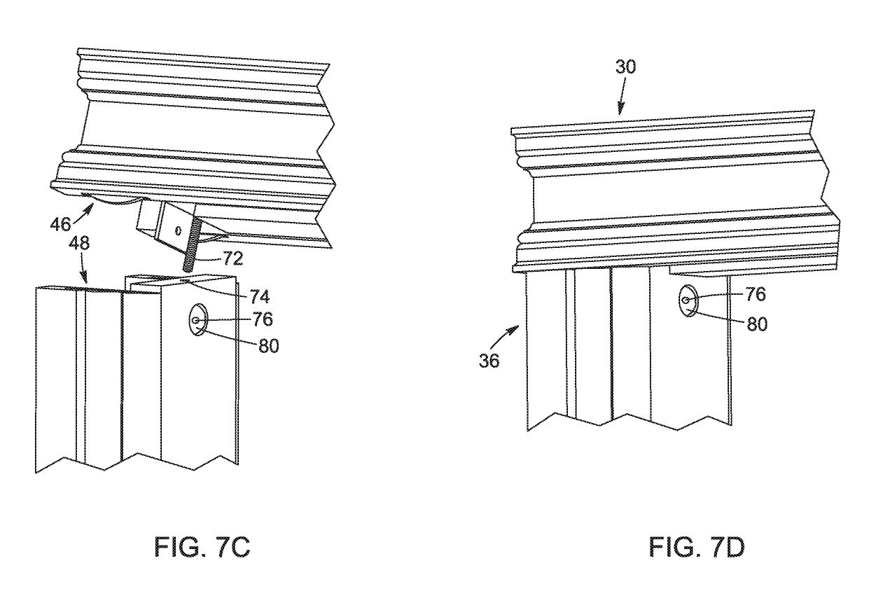

Now referring to FIGS. 7A to 7D, the assembly further includes a recess 76 extending along a portion of the side jamb 36 or 38 proximate one of the two opposed ends 40,42 of the respective one of the side jambs 36,38. The recess 76 is communicating with the hole 74.

In the illustrated variant, the threaded rod 72 passes through the hole 74 and extends at least partially in the recess 76. The assembly 20 further includes a ball 80 (also referred to as “spherical washer” or a “fixing nut”) comprising a threaded hole removably engageable with the threaded rod 72, so as to firmly attached the head jamb 30 with the side jambs 36,38. For example, when the ball 80 is rotated in an anticlockwise direction (about an axis defined by the threaded rod 72), the side jamb 36 or 38 is secured to the head jamb 30. Conversely, when the ball 80 is rotated in a clockwise direction (about the axis defined by the threaded rod 72), the side jamb 36 or 38 is disengaged from (i.e. is no longer secured to) the head jamb 30.

As better illustrated in FIGS. 7C and 7D, the head jamb 30 is attached to the side jamb 36 through the threaded rod 72.

In an alternative embodiment, the side jambs 36,38 are attached to the side studs 26,28 by means of a screw and corresponding ball 80 inserted into the recess 76.

Once assembled (i.e. when the frame assembly 20 is mounted into the door or window casing), the head jamb 30 and the side jambs 36,38 are all secured to the top stud 24 and the side studs 26,28, respectively. As illustrated the two opposed ends 32, 34 of the head jamb 30 are maintained in contact with a corresponding side jamb 36,38 through the connecting mechanisms 44a,b.

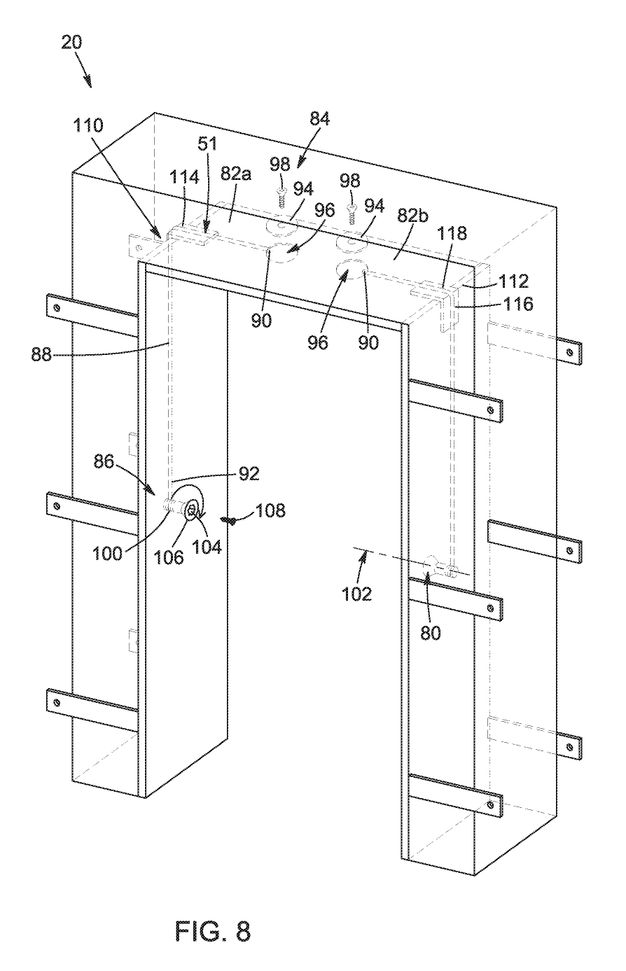

Now pointing to FIG. 8, the assembly may further include a pair of cabling systems 82a,b (the expression “the cabling system 82” herein referred to either the cabling system 82a or 82b). The cabling system 82 includes a fixing head 84, a winch 86, and a cable 88. For the sake of clarity and conciseness, the assembly 20 will be described as having only one cabling system 82, but it will be readily understood by one skilled in the art that the frame assembly 20 as described in the present description may comprise one or two cabling systems 82. Accordingly, the assembly 20 may comprise one or two fixing head(s) 84, one or two winch(es) 84, and one or two cable(s) 88.

The fixing head 84 is mounted onto the head jamb 30. Alternatively, the fixing head 84 could be mounted onto the top stud 24, or onto/into a wall portion located near the top stud 24. In the illustrated embodiment, the fixing head 84 is a metal ball 94.

The assembly may further include a recess 96 and restraining elements 98. The recess 96 is provided onto the head jamb 30 for receiving the metal ball 94. That is, the recess 96 is configured, sized and shaped for supporting the metal ball 94. In some scenarios (e.g. when the fixing head 84 is mounted onto the top stud 24), the recess 96 could be provided elsewhere (e.g. onto the top stud 24), so as to receive the fixing head 84. As its name entails, the restraining elements 98 are restraining a possible displacement of the fixing head 84 (i.e. it is maintaining or holding the metal ball 94 into the recess 96). For example, the restraining elements 98 may be a pair of screw passing through the metal ball 94 and corresponding washer.

The winch 86 is mounted onto the side jambs (36 or 38). In the illustrated embodiment, two winches 86 are provided. A first one is mounted onto the side jamb 36, while a second one is mounted onto the side jamb 38. Alternatively, the winch could be mounted onto the side studs 26,28 or onto-into a wall portion located near the side studs 26,28.

The cable 88 has a first end 90 engaged with the fixing head 84 and a second end 92 rotatably attached to the winch 86. In the illustrated embodiment, the first end 90 is attached to the metal ball 94.

The first end 90 may be removably engaged with the fixing head 84. For example, it may be wound up about the fixing head 84. Alternatively, it could also be permanently engaged with fixing head 84. For example, the first end of the cable 88 could be weld to the fixing head 84.

In the illustrated variant, the winch 86 includes a shaft 100 defining a rotation axis 102. The winch 86 also has a hexagonal top head 104 affixed to the shaft 100. The winch 86 is rotatable about the rotation axis 102 through rotation of the hexagonal top head 104. The rotation of the hexagonal top head 104 allows to wind up the cable 88 onto the shaft 102 of the winch 86.

In some embodiments, the winch 86 further includes a winch head 106 and a locking element 108. The locking element 108 is engageable with at least one of the winch head 106, the cable 88 and the shaft 100. The locking element 108 may be embodied by a pin or a mechanism allowing to lock the winch 86 (i.e. limit or restrain its rotation about the rotation axis 102).

As illustrated, the head jamb 30 defines two top corners 110, 112 with the pair of side jambs 36,38. In this scenario, the assembly 20 may further include reinforcement elements 114, 126, each being provided at a respective one of the two top corners 110,112. For example, the reinforcement elements 114,116 may be L-shaped mounting bracket 118. The L-shaped mounting bracket 118 is typically made from metal, but could alternatively be made from wood, plastic, ceramic, alloys, variants or combinations thereof. It will be readily understood that the material forming the L-shaped mounting bracket 118 is typically made from a non-deformable material, namely a material that is mechanically resistant.

In the illustrated embodiment, the L-shaped mounting bracket 118 is mounted onto the top corner 110 or 112. The head jamb 30 comprises a groove 31 into which is inserted the cable 88. The cable 88 extends from the fixing head 84 to the winch 86, while passing onto an exterior surface of the L-shaped mounting bracket 118 (i.e. the one that is not in contact with the head jamb 30 and the side jamb 36 or 38). The L-shaped mounting bracket 118 may then be useful for maintaining the angle formed by the head jamb 30 and the side jambs 36,38 near the top corners 110,112, when the cable is put under tension (through the rotation of the winch 86)

The cable 51 may be put under tension by the rotation of the hexagonal top head 104 of the winch 86, for example by using the appropriate tool (e.g. an “Allen” key). It will be understood that the cable could be tensioned by the rotation of a screw, a nut or any components allowing to adjust the tension in the cable by means of a rotation.

The head jamb 30 forms two substantially perpendicular angles with the side jambs 36, 38. Alternatively, the angle defined by the head jamb 30 and the side jambs 36, 38 could take any value between 0 and 180 degrees, so as to accommodate the geometrical configuration (size, shape and dimensions) of the door or window opening

The various embodiments of the frame assembly of the present description may be useful for addressing some of the challenges associated with uninstalling a frame assembly onto a door or window casing without damaging the components included in the frame assembly. This feature of the frame assembly may be useful if the user wants to reinstall the frame assembly into the same or another door or window casing.

In accordance with embodiments, there is also provided a method for removably installing a frame assembly into a door or window casing. As previously described, the casing has a top and two side studs.

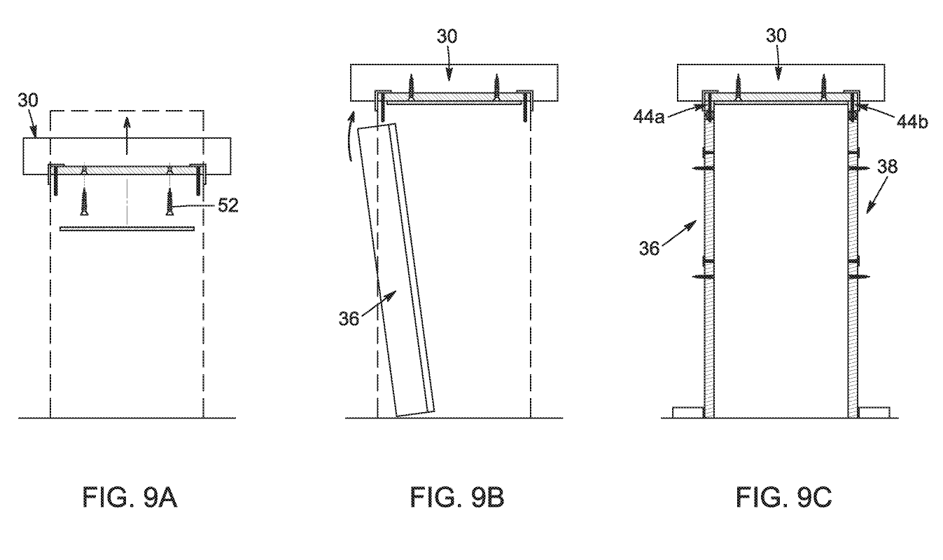

Referring to FIGS. 9A to 9C, a method for removably installing a frame assembly into a door or window casing is shown

The method comprises a step of removably securing a head jamb to the top stud, the head jamb having two opposed ends.

The method also comprises a step of removably securing a pair of side jambs to a respective one of the two side studs, each side jamb having two opposed ends.

The method further comprises a step of connecting a respective one of the side jambs with a corresponding end of the head jamb through a pair of connecting mechanisms each comprising a first component provided at the corresponding end of the head jamb and a second component provided at one of the two opposed ends of the respective one of the side jambs, the first and second components being removably engaged.

The resulting frame assembly 20 is illustrated in FIG. 9C. A fully assembled (i.e. installed) frame assembly system is shown.

When the above-mentioned steps are successively carried out the frame assembly may be installed or uninstalled from the door or window casing.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

What is claimed is:

1. A frame assembly for installation into a door or window casing, the casing having a top and two side studs, the assembly comprising;
a head jamb removably securable to the top stud, the head jamb having two opposed ends;
a pair of side jambs, each side jamb having two opposed ends and being removably securable to a respective one of the two side studs; and
a pair of connecting mechanisms, each for connecting a respective one of the side jambs with a corresponding end of the head jamb and comprising:
a first component provided at the corresponding end of the head jamb; and
a second component provided at one of the two opposed ends of the respective one of the side jambs, said first and second components being removably engageable, thereby allowing the frame assembly to be installed and uninstalled from the door or window casing.

2. The assembly according to claim 1, further comprising top securing components for removably securing the head jamb to the top stud.

3. The assembly of claim 2, wherein the top securing components comprise at least one screw and wherein the head jamb comprises at least one hole traversable by said at least one screw.

4. The assembly according to claim 1, wherein each of said side jambs comprises an adjustment mechanism comprising:
at least one screw mounted on each of said side jambs; and
at least one washer mounted onto said at least one screw, said at least one washer being engageable with a respective side stud upon rotation of said at least one screw.

5. The assembly according to claim 1, wherein the head jamb and each side jambs comprise:
a support base having two longitudinally-extending sides; and
two casing mouldings mounted to the support base along the two longitudinally-extending sides and perpendicularly extending therefrom, towards the casing.

6. The assembly according to claim 1, wherein the first component of each of the connecting mechanisms is a threaded rod.

7. The assembly according to claim 1, wherein the second component is a hole in which the first component is removably insertable.

8. The assembly according to claim 7, further comprising a recess extending along a portion of the side jamb proximate said one of the two opposed ends of the respective one of the side jambs, the recess communicating with the hole.

9. The assembly according to claim 8, wherein the threaded rod passes through the hole and extends at least partially in the recess.

10. The assembly of claim 9, further comprising a fixing nut removably engageable with the threaded rod.

11. The assembly according to claim 1, further comprising a pair of cabling systems, each cabling system comprising:
a fixing head mounted onto the head jamb;
a winch mounted onto a respective one of the pair of side jambs; and
a cable having a first end engaged with the fixing head and a second end rotatably attached to the winch.

12. The assembly according to claim 11, wherein the fixing head is a metal ball.

13. The assembly according to claim 12, the assembly further comprising:
a recess provided onto the head jamb for receiving said metal ball; and
restraining elements for holding said metal ball into said recess.

14. The assembly according to claim 13, wherein the restraining elements are at least one pair of screw and corresponding washer.

15. The assembly according to claim 11, wherein the winch comprises a shaft defining a rotation axis and a hexagonal top head affixed to said shaft, the winch being rotatable about the rotation axis through rotation of the hexagonal top head, thereby allowing to wind up the cable onto the shaft of the winch.

16. The assembly according to claim 11, wherein the winch further comprises a winch head and a locking element engaging with at least one of the winch head, the cable and the shaft.

17. The assembly according to claim 1, wherein the head jamb defines two top corners with the pair of side jambs, the assembly further comprising reinforcement elements provided at the two top corners.

18. The assembly according to claim 1, wherein the reinforcement elements are L-shaped mounting bracket.

19. A method for removably installing a frame assembly into a door or window casing, the casing having a top and two side studs, the method comprising:
removably securing a head jamb to the top stud, the head jamb having two opposed ends;
removably securing a pair of side jambs to a respective one of the two side studs, each side jamb having two opposed ends; and
connecting a respective one of the side jambs with a corresponding end of the head jamb through a pair of connecting mechanisms each comprising a first component provided at the corresponding end of the head jamb and a second component provided at one of the two opposed ends of the respective one of the side jambs, said first and second components being removably engaged, thereby allowing the frame assembly to be installed and uninstalled from the door or window casing.
